(19) United States
(12) Patent Application Publication
(10) Pub. No.: US 2026/0249278 A1
(43) Pub. Date: Aug. 27, 2026

(54) NOBLE METAL OXIDE CLUSTER CATALYST ANCHORED ON COBALT-BASED NANOSHEETS AND PREPARATION METHODS THEREOF

(71) Applicant: JIANGXI NORMAL UNIVERSITY, Nanchang (CN)

(72) Inventors: Chunting HE, Nanchang (CN); Jia ZHANG, Nanchang (CN); Liming CAO, Nanchang (CN); Haihua HUANG, Nanchang (CN); Meiqian HE, Nanchang (CN)

(73) Assignee: JIANGXI NORMAL UNIVERSITY, Nanchang (CN)

(21) Appl. No.: 19/533,343

(22) Filed: Feb. 9, 2026

(30) Foreign Application Priority Data
Feb. 25, 2025 (CN) 202510208046.0

(51) Int. Cl. B01J 23/89; B01J 23/42; B01J 35/30

(52) U.S. Cl. CPC B01J 23/8913; B01J 23/42; B01J 35/393

(57) ABSTRACT

The present disclosure discloses a noble metal oxide cluster catalyst anchored on cobalt-based nanosheets and a preparation method thereof. The preparation method includes mixing a cobalt acetate solution, a metal salt solution, ammonium metavanadate, and acetylene black uniformly, stirring at a temperature in a range of 50 °C to 100 °C, and filtering to collect a sample; and subjecting the sample to vacuum drying, pyrolyzing the sample under air atmosphere, to obtain the noble metal oxide cluster catalyst anchored on cobalt-based nanosheets.

### CROSS-REFERENCE TO RELATED APPLICATIONS

This application claims priority to Chinese Patent Application No. 202510208046.0, filed on February 25, 2025, the contents of which are hereby incorporated by reference.

### TECHNICAL FIELD

The present disclosure generally relates to a field of catalyst technology, and in particular to, a noble metal oxide cluster catalyst anchored on cobalt-based nanosheets and a preparation method thereof.

### BACKGROUND

Ruthenium dioxide (RuO₂), as a material with high catalytic activity, exhibits excellent catalytic performance in many organic reactions and electrocatalytic reactions. The unique electronic structure and excellent conductivity of RuO₂ enable RuO₂ to exhibit extremely high catalytic activity in an electrocatalytic water splitting reaction, especially in an oxygen evolution reaction (OER). However, although RuO₂ has excellent catalytic performance, the high cost and scarcity of resources of RuO₂ severely limit the feasibility of RuO₂ in large-scale commercial applications. Therefore, it is crucial to develop efficient and low-cost electrocatalysts to promote the development of the electrocatalytic field.

### SUMMARY

One or more embodiments of the present disclosure provide a preparation method for a noble metal oxide cluster catalyst anchored on cobalt-based nanosheets. The preparation method includes: mixing a cobalt acetate solution, a metal salt solution, ammonium metavanadate, and acetylene black uniformly, stirring at a temperature in a range of 50 °C to 100 °C, and filtering to collect a sample; wherein a metal species involved in the metal salt solution includes at least one of Ru, Pd, or Pt; and subjecting the sample to vacuum drying, and pyrolyzing the sample under air atmosphere, to obtain the noble metal oxide cluster catalyst anchored on cobalt-based nanosheets; wherein a concentration of the cobalt acetate solution is in a range of 0.05 mol/L to 0.07 mol/L; a volume ratio of the cobalt acetate solution to the metal salt solution is in a range of 3:1 to 20:1; a mass ratio of the ammonium metavanadate to the acetylene black is in a range of 1:1 to 10:1; the catalyst obtained by the preparation method includes ultrathin nanosheets having a thickness in a range of 1 nm to 3 nm; the noble metal oxide loaded on the cobalt-based nanosheets is in a form of nanoclusters; a loading amount of noble metal is in a range of 0.8 wt% to 5.1 wt%; and an average particle size of the noble metal oxide nanoclusters loaded on the cobalt-based nanosheets is in a range of 0.7 nm to 1.5 nm.

In some embodiments, the volume ratio of the cobalt acetate solution to the metal salt solution is in a range of 3:1 to 20:1, and the mass ratio of the ammonium metavanadate to the acetylene black is in a range of 1:1 to 10:1.

In some embodiments, a salt species involved in the metal salt solution includes at least one of a metal acetate salt, a metal chloride salt, or a vanadate.

In some embodiments, a concentration of the metal salt solution is in a range of 0.06 mol/L to 0.4 mol/L.

In some embodiments, a temperature of the vacuum drying is in a range of 50 °C to 100 °C, and a duration of the vacuum drying is in a range of 12 hours to 24 hours.

In some embodiments, the pyrolyzing the sample under air atmosphere includes: heating the sample after the vacuum drying in a tube furnace under air atmosphere at a heating rate in a range of 5 °C/min to 20 °C/min to a temperature in a range of 300 °C to 500 °C; maintaining the temperature for a duration in a range of 5 h to 15 h; and naturally cooling to room temperature, to obtain the noble metal oxide cluster catalyst anchored on cobalt-based nanosheets.

One or more embodiments of the present disclosure further provide a noble metal oxide cluster catalyst anchored on cobalt-based nanosheets. The catalyst is obtained by the preparation method.

In some embodiments, the noble metal oxide includes RuO₂, PdO, and PtO₂.

In some embodiments, the catalyst includes RuO₂@CoV₂O₆, PdO@CoV₂O₆, and PtO₂@CoV₂O₆.

In some embodiments, the cobalt-based nanosheets are cobalt vanadate nanosheets.

In some embodiments, the noble metal oxide loaded on the cobalt vanadate nanosheets is in a form of nanoclusters. A loading amount of noble metal is in a range of 0.8 wt% to 5.1 wt%.

In some embodiments, the catalyst includes ultrathin nanosheets having a thickness in a range of 1 nm to 3 nm. An average particle size of the noble metal oxide nanoclusters loaded on the cobalt vanadate nanosheets is in a range of 0.7 nm to 1.5 nm.

One or more embodiments of the present disclosure further provide an application of the catalyst described above in an energy catalysis field. The application includes applying the catalyst to a water splitting reaction, an oxygen reduction reaction, a carbon dioxide reduction reaction, and an organic catalytic reaction.

### BRIEF DESCRIPTION OF THE DRAWINGS

FIG. 1 is an X-ray powder diffraction pattern of RuO₂@CoV₂O₆ in Embodiment 1 of the present disclosure.

FIG. 2 is an atomic force microscopy image of RuO₂@CoV₂O₆ in Embodiment 1 of the present disclosure.

FIG. 3 is a transmission electron microscopy image of RuO₂@CoV₂O₆ in Embodiment 1 of the present disclosure.

FIG. 4 is a spherical aberration-corrected transmission electron microscopy image of RuO₂@CoV₂O₆ in Embodiment 1 of the present disclosure.

FIG. 5 is a linear sweep voltammetry curve of RuO₂@CoV₂O₆ on a glassy carbon electrode for an OER in Embodiment 1 of the present disclosure.

FIG. 6 is a linear sweep voltammetry curve of RuO₂@CoV₂O₆ on a carbon cloth electrode for an OER in Embodiment 1 of the present disclosure.

FIG. 7 is a Tafel plot of RuO₂@CoV₂O₆ in Embodiment 1 of the present disclosure.

FIG. 8 is a constant voltage electrolysis plot of RuO₂@CoV₂O₆ at a current density of 500 mA·cm⁻² in Embodiment 1 of the present disclosure.

FIG. 9 is an electrochemical impedance spectroscopy plot of RuO₂@CoV₂O₆ in Embodiment 1 of the present disclosure.

FIG. 10 is an electrochemical specific surface area plot of RuO₂@CoV₂O₆ in Embodiment 1 of the present disclosure.

FIG. 11 is a conversion plot of the electrochemical specific surface area of RuO₂@CoV₂O₆ in Embodiment 1 of the present disclosure.

FIG. 12 is an X-ray powder diffraction pattern of PdO@CoV₂O₆ in Embodiment 2 of the present disclosure.

FIG. 13 is a linear sweep voltammetry curve of PdO@CoV₂O₆ on a glassy carbon electrode for an OER in Embodiment 2 of the present disclosure.

FIG. 14 is a constant voltage electrolysis plot of PdO@CoV₂O₆ at the current density of 500 mA·cm⁻² in Embodiment 2 of the present disclosure.

FIG. 15 is an X-ray powder diffraction pattern of PtO₂@CoV₂O₆ in Embodiment 3 of the present disclosure.

FIG. 16 is a linear sweep voltammetry curve of PtO₂@CoV₂O₆ on a glassy carbon electrode for an OER in Embodiment 3 of the present disclosure.

FIG. 17 is a constant current electrolysis plot of PtO₂@CoV₂O₆ at a voltage of 0.78 V in Embodiment 3 of the present disclosure.

FIG. 18 is an X-ray powder diffraction pattern of RuO₂@CoV₂O₆ -1, RuO₂@CoV₂O₆ -2, and RuO₂@CoV₂O₆ -4 in Embodiment 4 of the present disclosure.

FIG. 19 is a transmission electron microscopy image of RuO₂@CoV₂O₆ -1 in Embodiment 4 of the present disclosure.

FIG. 20 is a transmission electron microscopy image of RuO₂@CoV₂O₆ -2 in Embodiment 4 of the present disclosure.

FIG. 21 is a transmission electron microscopy image of RuO₂@CoV₂O₆ -4 in Embodiment 4 of the present disclosure.

FIG. 22 is a linear sweep voltammetry curve of RuO₂@CoV₂O₆ -1 to RuO₂@CoV₂O₆ -4 on a glassy carbon electrode for an OER in Embodiment 4 of the present disclosure.

FIG. 23 is a linear sweep voltammetry curve of RuO₂@CoV₂O₆ -3 and RuO₂@CoV₂O₆ -5 to RuO₂@CoV₂O₆ -8 on a glassy carbon electrode for an OER in Embodiment 5 of the present disclosure.

### DETAILED DESCRIPTION

To make the technical problems, technical solutions, and beneficial effects of the embodiments of the present disclosure clearer, the present disclosure is further described in detail below with reference to the drawings and embodiments. It should be understood that the specific embodiments described herein are merely used to explain the present disclosure and are not intended to limit the present disclosure.

Noble metals are scarce and expensive, resulting in a high cost of catalysts prepared from the noble metals. The noble metal oxide (e.g., RuO₂, PdO, and PtO₂) is in a form of clusters and loaded on a carrier with a high specific surface area and excellent conductivity to prepare a catalyst in the embodiments of the present disclosure. The catalyst not only can significantly reduce the amount of noble metal oxides and lower the cost but also can regulate the electronic structure of the catalyst and optimize the catalytic performance of the catalyst for an electrocatalytic water splitting reaction through an interaction between the carrier and the noble metal oxide clusters.

Embodiments of the present disclosure provide a preparation method for a noble metal oxide cluster catalyst anchored on cobalt-based nanosheets. The preparation method includes: mixing a cobalt acetate solution, a metal salt solution, ammonium metavanadate, and acetylene black uniformly, stirring at a temperature in a range of 50 °C to 100 °C, and filtering to collect a sample; and subjecting the sample to vacuum drying, and pyrolyzing the sample under air atmosphere to obtain the noble metal oxide cluster catalyst anchored on cobalt-based nanosheets.

In some embodiments, a concentration of the cobalt acetate solution is in a range of 0.05 mol/L to 0.07 mol/L. In some embodiments, the concentration of the cobalt acetate solution is in a range of 0.05 mol/L to 0.06 mol/L. In some embodiments, the concentration of the cobalt acetate solution is in a range of 0.06 mol/L to 0.07 mol/L. In some embodiments, the concentration of the cobalt acetate solution is 0.05 mol/L, 0.055 mol/L, 0.058 mol/L, 0.06 mol/L, 0.062 mol/L, 0.065 mol/L, 0.067 mol/L, 0.07 mol/L, or the like.

In some embodiments, a metal species involved in the metal salt solution includes at least one of Ru, Pd, and Pt.

In some embodiments, a salt species involved in the metal salt solution includes at least one of a metal acetate salt, a metal chloride salt, or a vanadate.

In some embodiments, a concentration of the metal salt solution is in a range of 0.06 mol/L to 0.4 mol/L. In some embodiments, the concentration of the metal salt solution is in a range of 0.1 mol/L to 0.4 mol/L. In some embodiments, the concentration of the metal salt solution is in a range of 0.2 mol/L to 0.4 mol/L. In some embodiments, the concentration of the metal salt solution is in a range of 0.2 mol/L to 0.3 mol/L. In some embodiments, the concentration of the metal salt solution is in a range of 0.06 mol/L to 0.2 mol/L. In some embodiments, the concentration of the metal salt solution is 0.06 mol/L, 0.067 mol/L, 0.1 mol/L, 0.15 mol/L, 0.2 mol/L, 0.23 mol/L, 0.25 mol/L, 0.3 mol/L, 0.4 mol/L, or the like.

In some embodiments, a volume ratio of the cobalt acetate solution to the metal salt solution is in a range of 3:1 to 20:1. In some embodiments, the volume ratio of the cobalt acetate solution to the metal salt solution is in a range of 4:1 to 20:1. In some embodiments, the volume ratio of the cobalt acetate solution to the metal salt solution is in a range of 5:1 to 20:1. In some embodiments, the volume ratio of the cobalt acetate solution to the metal salt solution is in a range of 6:1 to 20:1. In some embodiments, the volume ratio of the cobalt acetate solution to the metal salt solution is in a range of 8:1 to 20:1. In some embodiments, the volume ratio of the cobalt acetate solution to the metal salt solution is in a range of 10:1 to 20:1. In some embodiments, the volume ratio of the cobalt acetate solution to the metal salt solution is in a range of 12:1 to 20:1. In some embodiments, the volume ratio of the cobalt acetate solution to the metal salt solution is in a range of 15:1 to 20:1. In some embodiments, the volume ratio of the cobalt acetate solution to the metal salt solution is in a range of 19:1 to 20:1. In some embodiments, the volume ratio of the cobalt acetate solution to the metal salt solution is 3:1, 4:1, 5:1, 5.5:1, 6:1, 9:1, 10:1, 12:1, 15:1, 18:1, 19:1, 20:1, or the like.

In some embodiments, a concentration of the ammonium metavanadate solution is 0.05 mol/L.

In some embodiments, a molar ratio of the cobalt acetate solution to the ammonium metavanadate is in a range of 1:5-2.5:5. In some embodiments, a molar ratio of the cobalt acetate solution to the ammonium metavanadate is in a range of 1.2:5-2.5:5. In some embodiments, a molar ratio of the cobalt acetate solution to the ammonium metavanadate is in a range of 1.5:5-2.5:5. In some embodiments, a molar ratio of the cobalt acetate solution to the ammonium metavanadate is in a range of 1.8:5-2.5:5. In some embodiments, a molar ratio of the cobalt acetate solution to the ammonium metavanadate is 1:5, 1.1:5, 1.3:5, 1.5:5, 1.7:5, 1.9:5, 2.1:5, 2.3:5, 2.5:5, or the like.

In some embodiments, a mass ratio of the ammonium metavanadate to the acetylene black is in a range of 1:1 to 10:1. In some embodiments, the mass ratio of the ammonium metavanadate to the acetylene black is in a range of 3:1 to 10:1. In some embodiments, the mass ratio of the ammonium metavanadate to the acetylene black is in a range of 5:1 to 10:1. In some embodiments, the mass ratio of the ammonium metavanadate to the acetylene black is in a range of 7:1 to 10:1. In some embodiments, the mass ratio of the ammonium metavanadate to the acetylene black is in a range of 8:1 to 10:1. In some embodiments, the mass ratio of the ammonium metavanadate to the acetylene black is 1:1, 5:1, 6:1, 7:1, 7.5:1, 8:1, 10:1, or the like.

In some embodiments, the temperature of the stirring is in the range of 50 °C to 100 °C. In some embodiments, the temperature of the stirring is in a range of 80 °C to 100 °C. In some embodiments, the temperature of the stirring is in a range of 50 °C to 80 °C. In some embodiments, the temperature of the stirring is 50 °C, 70 °C, 80 °C, 90 °C, 100 °C, or the like.

In some embodiments, a duration of the stirring is 5 h.

The sample refers to a composite precursor formed after the cobalt acetate solution, the metal salt solution, the ammonium metavanadate, and the acetylene black are processed. A processing for the cobalt acetate solution, the metal salt solution, the ammonium metavanadate, and the acetylene black may include mixing, heating, stirring, filtering, or the like.

In some embodiments, a temperature of the vacuum drying is in a range of 50 °C to 100 °C. In some embodiments, the temperature of the vacuum drying is in a range of 60 °C to 100 °C. In some embodiments, the temperature of the vacuum drying is in a range of 60 °C to 80 °C. In some embodiments, the temperature of the vacuum drying is in a range of 60 °C to 70 °C. In some embodiments, the temperature of the vacuum drying is 50 °C, 60 °C, 70 °C, 80 °C, 100 °C, or the like.

In some embodiments, a duration of the vacuum drying is in a range of 12 h to 24 h. In some embodiments, the duration of the vacuum drying is in a range of 12 h to 20 h. In some embodiments, the duration of the vacuum drying is in a range of 12 h to 16 h. In some embodiments, the duration of the vacuum drying is 12 h, 15 h, 18 h, 20 h, 24 h, or the like.

The pyrolyzing refers to a process of heating the sample after the vacuum drying to cause decomposition, phase transition, crystallization, or the like.

In some embodiments, the pyrolyzing the sample under air atmosphere include heating the sample after the vacuum drying in a tube furnace under air atmosphere at a heating rate in a range of 5 °C/min to 20 °C/min to a temperature in a range of 300 °C to 500 °C; maintaining the temperature for a duration in a range of 5 h to 15 h, and naturally cooling to room temperature, to obtain the noble metal oxide cluster catalyst anchored on cobalt-based nanosheets.

The tube furnace under air atmosphere refers to an air atmosphere inside the tube furnace.

In some embodiments, the heating rate is in the range of 5 °C/min to 20°C/min. In some embodiments, the heating rate is in a range of 10°C/min to 20°C/min. In some embodiments, the heating rate is in a range of 5 °C/min to 10°C/min. In some embodiments, the heating rate is 5 °C/min, 10°C/min, 20°C/min, or the like.

In some embodiments, the temperature reached by the heating is in the range of 300 °C to 500 °C. In some embodiments, the temperature reached by the heating is in a range of 400 °C to 500 °C. In some embodiments, the temperature reached by the heating is in a range of 450 °C to 500 °C. In some embodiments, the temperature reached by the heating is 300 °C, 400 °C, 500 °C, or the like.

In some embodiments, the duration for maintaining the temperature is in the range of 5 h to 15 h. In some embodiments, the duration for maintaining the temperature is in a range of 10 h to 15 h. In some embodiments, the duration for maintaining the temperature is 5 h, 10 h, 15 h, or the like.

The naturally cooling refers to cooling with the tube furnace. That is, after the sample after the vacuum drying is subjected to the heating and the maintaining the temperature for the duration in the tube furnace, the sample in the tube furnace is cooled together with the tube furnace.

A catalyst prepared by the preparation method according to embodiments of the present disclosure is the noble metal oxide cluster catalyst anchored on cobalt-based nanosheets. The catalyst includes ultrathin nanosheets having a thickness in a range of 1 nm to 3 nm. The noble metal oxide loaded on the cobalt-based nanosheets is in a form of nanoclusters. A loading amount of noble metal is in a range of 0.8 wt% to 5.1 wt%. An average particle size of the noble metal oxide nanoclusters loaded on the cobalt-based nanosheets is in a range of 0.7 nm to 1.5 nm.

A noble metal oxide (e.g., RuO₂, PdO, and PtO₂) nanocluster catalyst (e.g., RuO₂@CoV₂O₆, PdO@CoV₂O₆, and PtO₂@CoV₂O₆) anchored on the cobalt-based nanosheets (e.g., cobalt vanadate nanosheets) is prepared through a simple one-pot synthesis and calcination manner in embodiments of the present disclosure. The catalyst has a clear structure, high electrical/ionic conductivity, catalytic activity, and stability. The preparation method according to the embodiments of the present disclosure is simple and low-cost, requiring only about ¥ 32 (only 1/46 of RuO₂) per gram of catalyst.

Some embodiments of the present disclosure also provide a noble metal oxide cluster catalyst anchored on cobalt-based nanosheets. The catalyst is obtained by the aforementioned preparation method.

In some embodiments, the cobalt-based nanosheets are cobalt vanadate nanosheets.

As a two-dimensional material, the cobalt vanadate (CoV₂O₆) nanosheets provide abundant active sites for electrocatalytic reactions due to a unique layered structure and a high specific surface area of the cobalt vanadate nanosheets. The CoV₂O₆ nanosheets also have good chemical stability and corrosion resistance, enabling the CoV₂O₆ nanosheets to work stably in alkaline electrolytes for a long time. Therefore, loading the noble metal oxide (e.g., RuO₂, PdO, and PtO₂) clusters onto the CoV₂O₆nanosheets can combine advantages of the noble metal oxide and the CoV₂O₆ nanosheets to prepare an efficient and low-cost catalyst for an electrocatalytic water splitting reaction. In addition, Co in CoV₂O₆ conjugates with multivalent vanadium, palladium, and platinum, and additional active sites can produce a synergistic effect with electronic structures of RuO₂ clusters, PdO clusters, and PtO₂ clusters, further enhancing the catalytic performance of the catalyst for the OER. Therefore, using the CoV₂O₆ nanosheets to anchor the noble metal oxide (e.g., RuO₂, PdO, and PtO₂) clusters according to the embodiments of the present disclosure can prepare an efficient and low-cost catalyst for the electrocatalytic water splitting reaction, providing a new solution for industrial application of electrocatalytic water splitting technology, which is of great significance for promoting development of the energy catalysis field.

In some embodiments, the noble metal oxide includes RuO₂, PdO, and PtO₂.

In some embodiments, the noble metal oxide loaded on the cobalt-based nanosheets (e.g., the cobalt vanadate nanosheets) is in a form of nanoclusters.

In some embodiments, an average particle size of the noble metal oxide nanoclusters loaded on the cobalt-based nanosheets is in a range of 0.7 nm to 1.5nm. In some embodiments, the average particle size of the noble metal oxide nanoclusters loaded on the cobalt-based nanosheets is in a range of 1 nm to 1.5nm. In some embodiments, the average particle size of the noble metal oxide nanoclusters loaded on the cobalt-based nanosheets is in a range of 1 nm to 1.2nm. In some embodiments, the average particle size of the noble metal oxide nanoclusters loaded on the cobalt-based nanosheets is 0.7 nm, 1 nm, 1.3nm, 1.5nm, or the like.

A loading amount of noble metal refers to a percentage of a mass of catalytically active noble metal in the catalyst, relative to a total mass of the catalyst.

In some embodiments, the loading amount of noble metal is in a range of 0.8 wt% to 5.1 wt%. In some embodiments, the loading amount of noble metal is in a range of 1 wt% to 5.1 wt%. In some embodiments, the loading amount of noble metal is in a range of 1.5 wt% to 5.1 wt%. In some embodiments, the loading amount of noble metal is in a range of 2 wt% to 5.1 wt%. In some embodiments, the loading amount of noble metal is in a range of 2.5 wt% to 5.1 wt%. In some embodiments, the loading amount of noble metal is in a range of 3 wt% to 5.1 wt%. In some embodiments, the loading amount of noble metal is in a range of 3.5 wt% to 5.1 wt%. In some embodiments, the loading amount of noble metal is in a range of 4 wt% to 5.1 wt%. In some embodiments, the loading amount of noble metal is in a range of 4.5 wt% to 5.1 wt%. In some embodiments, the loading amount of noble metal is in a range of 5 wt% to 5.1 wt%. In some embodiments, the loading amount of noble metal is 0.8 wt%, 1 wt%, 1.5 wt%, 2 wt%, 2.5 wt%, 3 wt%, 3.5 wt%, 4 wt%, 4.5 wt%, 5 wt%, 5.1 wt%, or the like.

In some embodiments, the catalyst includes RuO₂@CoV₂O₆, PdO@CoV₂O₆, and PtO₂@CoV₂O₆.

In some embodiments, the catalyst includes ultrathin nanosheets having a thickness in a range of 1 nm to 3 nm. The ultrathin nanosheet refers to a two-dimensional sheet structure having a thickness in the range of 1 nm to 3 nm.

In some embodiments, a thickness of the catalyst is in a range of 1 nm to 3 nm. In some embodiments, the thickness of the catalyst is in a range of 1 nm to 2 nm. In some embodiments, the thickness of the catalyst is in a range of 2 nm to 3 nm. In some embodiments, the thickness of the catalyst is 1 nm, 1.5 nm, 2 nm, 2.5 nm, 3 nm, or the like.

The catalyst (e.g., RuO₂@CoV₂O₆, PdO@CoV₂O₆, and PtO₂@CoV₂O₆) prepared in the embodiments of the present disclosure can serve as an anode catalyst for electrocatalytic OER.

The catalyst (e.g., RuO₂@CoV₂O₆, PdO@CoV₂O₆, and PtO₂@CoV₂O₆) prepared in the embodiments of the present disclosure exhibits excellent electrochemical stability, maintaining good stability for 45 hours at a current density of 500 mA/cm². The catalyst also exhibits excellent OER catalytic performance. In a classic three-electrode system with an electrolyte of 1.0 M KOH, the catalyst requires an overpotential of only 167 mV to drive a current density of 10 mA·cm⁻² on a glassy carbon electrode. The catalyst requires overpotentials of only 230 mV and 201 mV to drive a current density of 100 mA·cm⁻² on the glassy carbon electrode and a carbon cloth electrode, respectively. Therefore, the noble metal oxide cluster catalyst anchored on the cobalt vanadate nanosheets prepared in the embodiments of the present disclosure has high potential application value in the field of energy catalysis. The catalyst can be used for other reactions such as an oxygen reduction reaction (ORR), a carbon dioxide reduction reaction (CO₂RR), and various organic catalytic reactions.

### Embodiment 1

A preparation method for a catalyst RuO₂@CoV₂O₆ included the following steps.

19 mL of 0.06 mol/L cobalt acetate solution, 1 mL of 0.2 mol/L ruthenium chloride solution, 50 mL of 0.05 mol/L ammonium metavanadate solution, and 40 mg of acetylene black were prepared.

The cobalt acetate solution, the ruthenium chloride solution, the ammonium metavanadate solution, and the acetylene black were mixed to obtain a mixture. After the acetylene black was fully dissolved, the mixture was stirred at 80 °C for 5 h and filtered to collect a sample.

Subsequently, the sample was washed with water and alcohol, centrifuged, and transferred to a vacuum oven for drying at 60 °C for 12 h to obtain a dried sample.

Finally, the dried sample was heated in a tube furnace at a heating rate of 10 °C/min to a temperature of 500 °C and maintained at the temperature of 500 °C for 15 hours, and cooled naturally to room temperature to obtain RuO₂@CoV₂O₆.

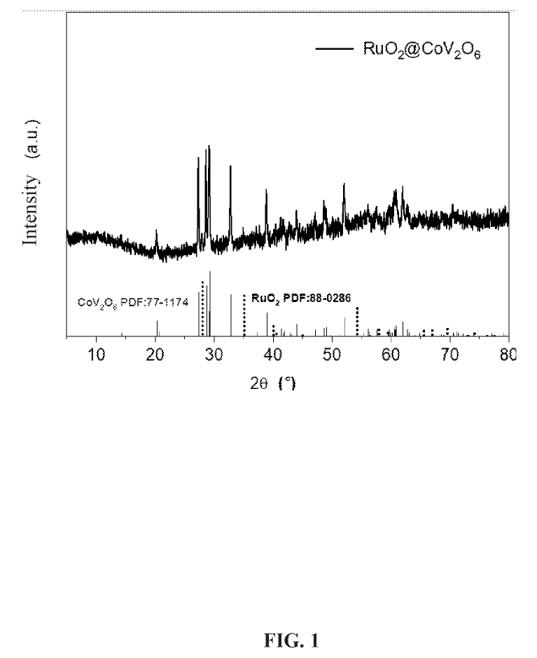

FIG. 1 is an X-ray powder diffraction pattern of RuO₂@CoV₂O₆ in Embodiment 1 of the present disclosure.

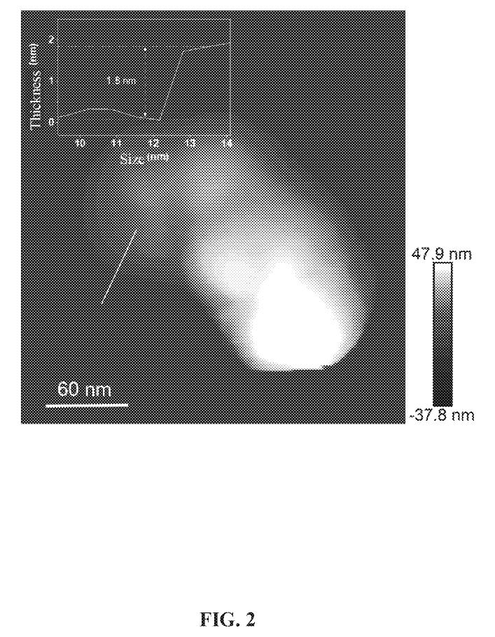

FIG. 2 is an atomic force microscopy image of RuO₂@CoV₂O₆ in Embodiment1 of the present disclosure.

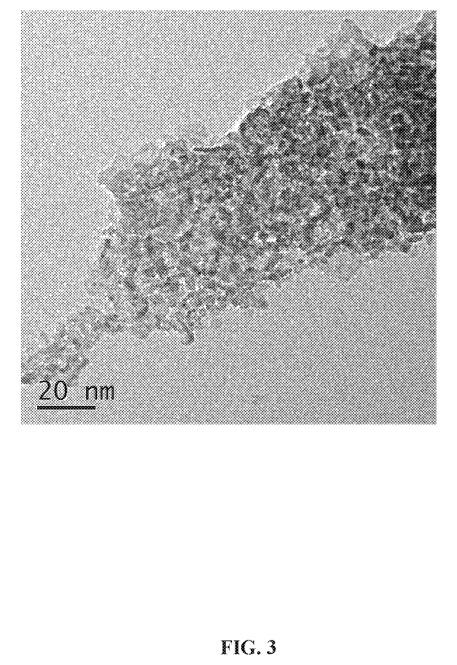

FIG. 3 is a transmission electron microscopy image of RuO₂@CoV₂O₆ in Embodiment 1 of the present disclosure.

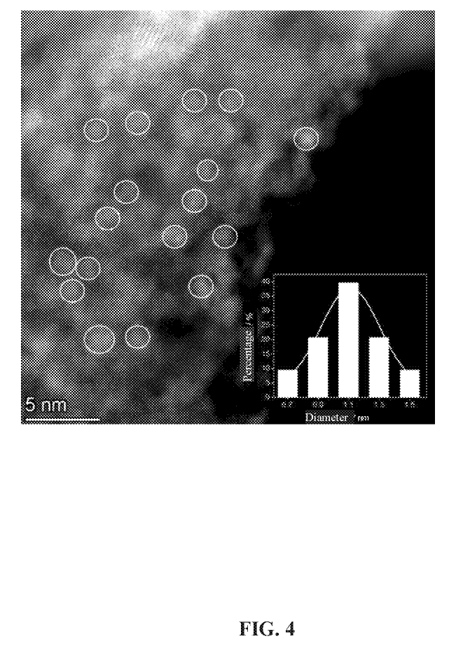

FIG. 4 is a spherical aberration-corrected transmission electron microscopy image of RuO₂@CoV₂O₆ in Embodiment 1 of the present disclosure.

The X-ray powder diffraction pattern of RuO₂@CoV₂O₆ is shown in FIG. 1. As shown in FIG. 1, the catalyst prepared in Embodiment 1 contains phases of both cobalt vanadate and ruthenium dioxide, proving the successful synthesis of RuO₂@CoV₂O₆. The atomic force microscopy image of RuO₂@CoV₂O₆ is shown in FIG. 2. As shown in FIG. 2, the catalyst prepared in Embodiment 1 is ultrathin nanosheets having a thickness in a range of 1 nm to 3 nm. The transmission electron microscopy image of RuO₂@CoV₂O₆ is shown in FIG. 3. As shown in FIG. 3, the catalyst prepared in Embodiment 1 has a sheet structure, and ruthenium dioxide clusters are uniformly anchored on cobalt vanadate nanosheets. The spherical aberration-corrected transmission electron microscopy image of RuO₂@CoV₂O₆ is shown in FIG. 4. As shown in FIG. 4, an average particle size of the ruthenium dioxide clusters in the catalyst prepared in Embodiment 1 is in a range of 0.7 nm to 1.5nm. The particle size is very small, indicating ultrafine ruthenium dioxide clusters.

Performance tests were conducted on RuO₂@CoV₂O₆ prepared in Embodiment 1. The test manner and result were as follows.

(1) Electrocatalytic OER Performance Test of RuO₂@CoV₂O₆

The electrocatalytic OER performance test of RuO₂@CoV₂O₆ obtained in Embodiment 1 was performed using a CHI760E electrochemical workstation at room temperature with a classic three-electrode system. The electrolyte was a 1.0 M KOH solution. A Hg/HgO electrode and a Pt sheet were used as a reference electrode and a counter electrode, respectively. 4 mg of RuO₂@CoV₂O₆ was taken. 150 uL of isopropanol and 10 uL of Nafion were added to RuO₂@CoV₂O₆ to obtain a first mixture. The first mixture was ultrasonicated for 20 minutes to obtain a second mixture. The second mixture was dropped onto a glassy carbon electrode and a carbon cloth electrode to serve as a working electrode.

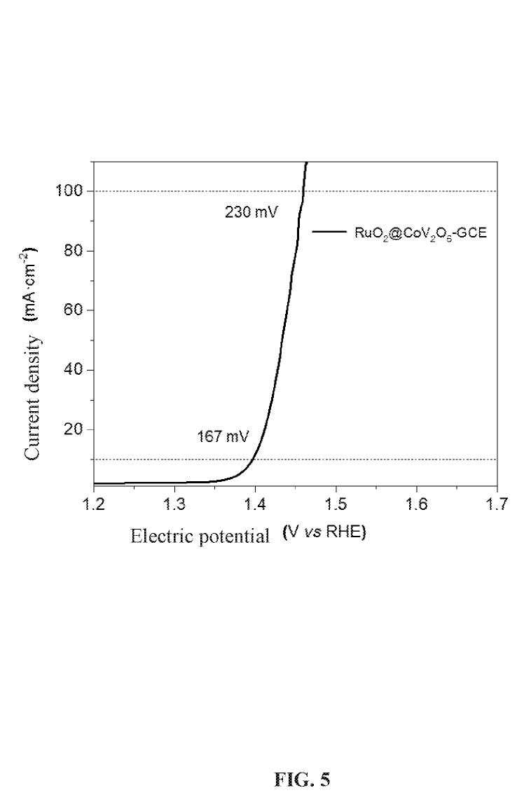

FIG. 5 is a linear sweep voltammetry curve of RuO₂@CoV₂O₆ on a glassy carbon electrode for an OER in Embodiment 1 of the present disclosure.

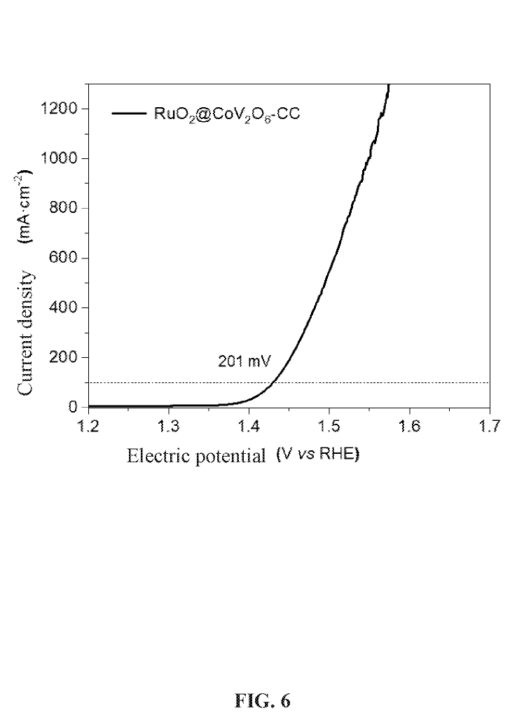

FIG. 6 is a linear sweep voltammetry curve of RuO₂@CoV₂O₆ on a carbon cloth electrode for an OER in Embodiment 1 of the present disclosure.

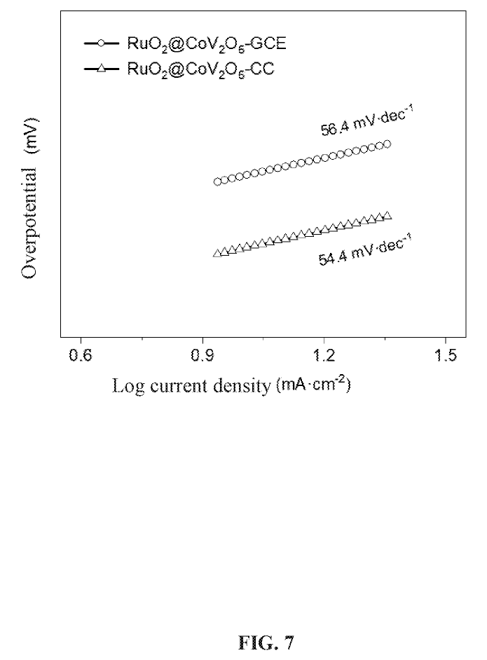

FIG. 7 is a Tafel plot of RuO₂@CoV₂O₆ in Embodiment 1 of the present disclosure.

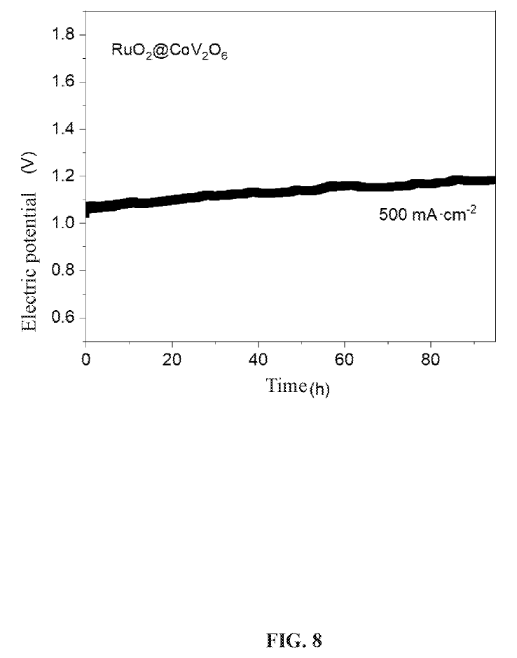

FIG. 8 is a constant voltage electrolysis plot of RuO₂@CoV₂O₆ at a current density of 500 mA·cm⁻² in Embodiment 1 of the present disclosure.

The linear sweep voltammetry curves shown in FIG. 5 and FIG. 6 were obtained at a scan rate of 5 mV/s. As shown in FIG. 5 and FIG. 6, RuO₂@CoV₂O₆ requires an overpotential of 167 mV to drive a current density of 10 mA·cm⁻² on the glassy carbon electrode. RuO₂@CoV₂O₆ requires overpotentials of 230 mV and 201 mV to drive a current density of 100 mA·cm⁻² on the glassy carbon electrode and the carbon cloth electrode, respectively. The Tafel plot shown in FIG. 7 was calculated from FIG. 5 and FIG. 6. As shown, a Tafel slope of RuO₂@CoV₂O₆ on the glassy carbon electrode is 56.4 mV·dec⁻¹ (RuO₂@CoV₂O₆-GCE in FIG. 7). A Tafel slope of RuO₂@CoV₂O₆ on the carbon cloth electrode is 54.4 mV·dec⁻¹ (RuO₂@CoV₂O₆-CC in FIG. 7). As shown in FIG. 8, RuO₂@CoV₂O₆ was electrolyzed for 95 h at a current density of 500 mA·cm⁻², and the performance decreased by only 9.7%, indicating that RuO₂@CoV₂O₆ has good stability.

(2) Electrochemical Impedance Spectroscopy Test of RuO₂@CoV₂O₆

An electrochemical impedance spectroscopy (EIS) test was performed at a frequency in a range of 0.01 Hz to 100 kHz.

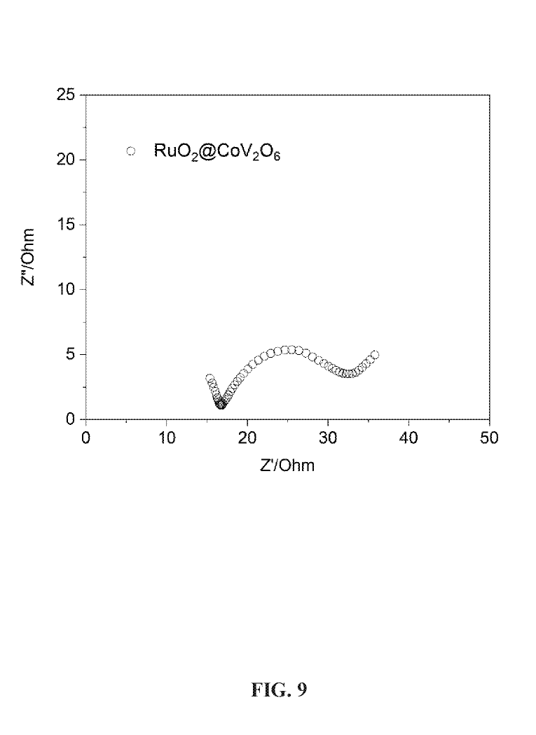

FIG. 9 is an electrochemical impedance spectroscopy plot of RuO₂@CoV₂O₆ in Embodiment 1 of the present disclosure.

The electrochemical impedance spectroscopy plot is shown in FIG. 9. As shown in FIG. 9, a charge transfer resistance of RuO₂@CoV₂O₆ is about 15 Ω. The charge transfer resistance of the catalyst is small, indicating that RuO₂@CoV₂O₆ has a fast reaction rate.

(3) Electrochemical specific surface area Test of RuO₂@CoV₂O₆

To determine the electrochemical surface area (ECSA), cyclic voltammetry (CV) measurement was used to investigate an electrochemical double-layer capacitance (C_{dl}) of the prepared electrode. The CV was performed in a non-Faradaic range (0.9 V-1.0 V vs. reversible hydrogen electrode (RHE)) at scan rates of 20 mV s⁻¹, 40 mV s⁻¹, 60 mV s⁻¹, 80 mV s⁻¹, and 100 mV s⁻¹. A linear plot was obtained by plotting a current density at 0.95 V vs. RHE against the scan rate. The C_{dl} is half of a slope of the linear plot and is used to represent the ECSA.

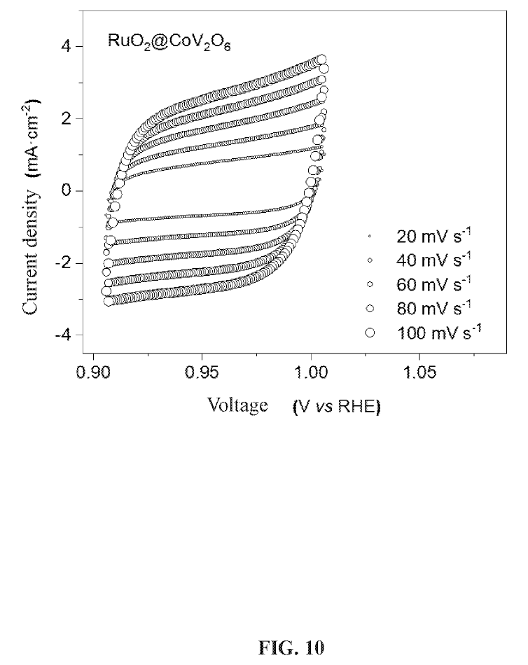

FIG. 10 is an electrochemical specific surface area plot of RuO₂@CoV₂O₆ in Embodiment of the present disclosure.

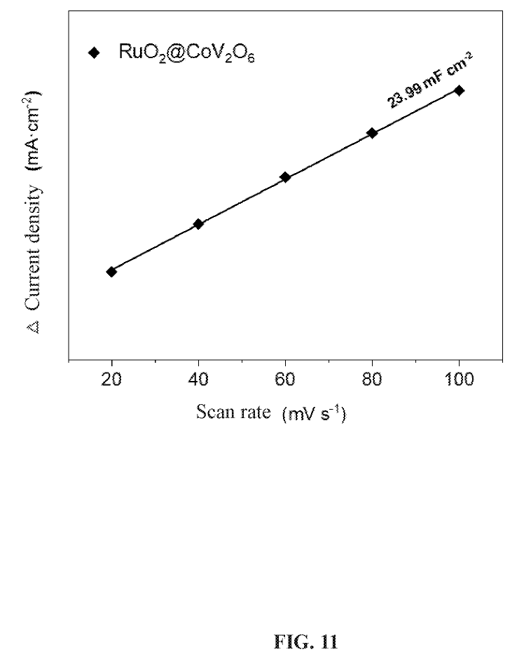

FIG. 11 is a conversion plot of the electrochemical specific surface area of RuO₂@CoV₂O₆ in Embodiment 1 of the present disclosure.

The electrochemical specific surface area plots are shown in FIG. 10 and FIG. 11. As shown in FIG. 10 and FIG. 11, RuO₂@CoV₂O₆ has a C_{dl} value of 23.99 mF cm⁻². RuO₂@CoV₂O₆ has a large electrochemical specific surface area and a large double-layer capacitance, indicating that the catalyst has a large number of active sites and good performance.

### Embodiment 2

A preparation method for a catalyst PdO@CoV₂O₆ included the following steps.

Embodiment 2 differed from Embodiment 1 in that the "ruthenium chloride solution" was changed to a "palladium chloride solution". Other steps were the same as those in Embodiment 1.

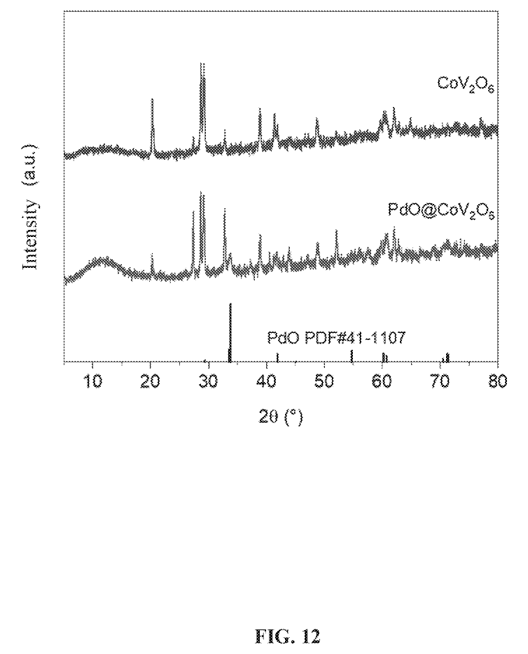

FIG. 12 is an X-ray powder diffraction pattern of PdO@CoV₂O₆ in Embodiment 2 of the present disclosure. As shown in FIG. 12, a cobalt vanadate phase and a palladium oxide phase coexist in PdO@CoV₂O₆. The coexistence proves that the catalyst PdO@CoV₂O₆ is successfully synthesized.

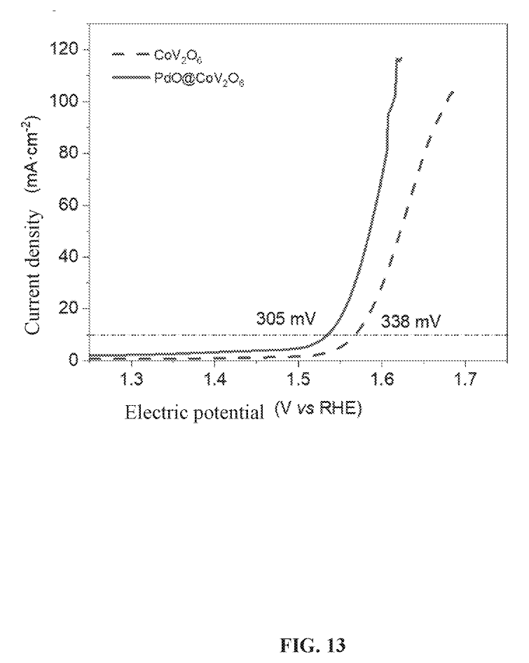

FIG. 13 is a linear sweep voltammetry curve of PdO@CoV₂O₆ on a glassy carbon electrode for an OER in Embodiment 2 of the present disclosure. Electrocatalytic OER performance test conditions for PdO@CoV₂O₆ obtained in Embodiment 2 are consistent with the conditions in Embodiment 1. As shown in FIG. 13, an overpotential required for PdO@CoV₂O₆ to drive a current density of 10 mA·cm⁻² on a glassy carbon electrode is 305 mV.

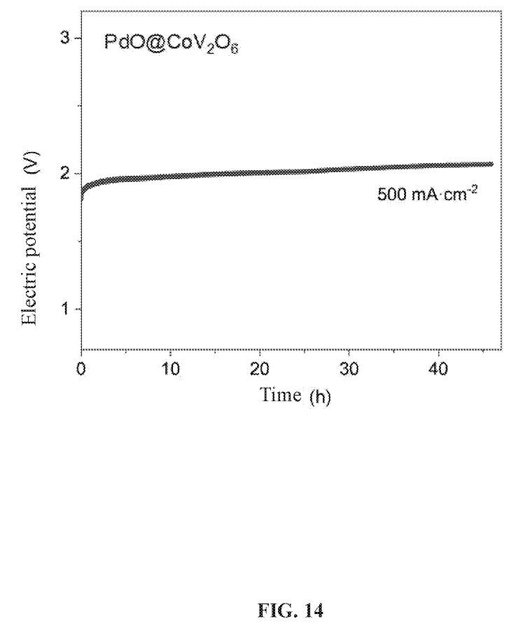

FIG. 14 is a constant voltage electrolysis plot of PdO@CoV₂O₆ at a current density of 500 mA·cm⁻² in Embodiment 2 of the present disclosure. As shown in FIG. 14, PdO@CoV₂O₆ was electrolyzed for 45 h at the current density of 500 mA·cm⁻², and the performance of PdO@CoV₂O₆ decreased by only 9.3%, indicating that PdO@CoV₂O₆ has very good stability.

### Embodiment 3

A preparation method for a catalyst PtO₂@CoV₂O₆ included the following steps.

Embodiment 3 differed from Embodiment 1 in that a "ruthenium chloride solution" was changed to a "platinum chloride solution". Other steps were the same as those in Embodiment 1.

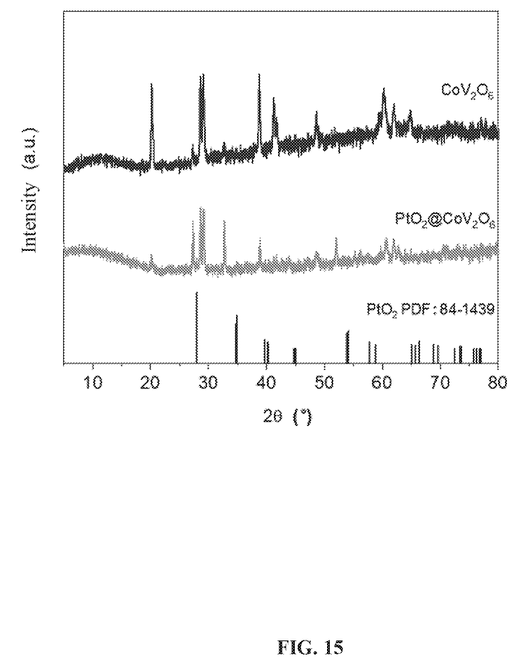

FIG. 15 is an X-ray powder diffraction pattern of PtO₂@CoV₂O₆ in Embodiment 3 of the present disclosure. As shown in FIG. 15, a cobalt vanadate phase and a platinum oxide phase coexist in PtO₂@CoV₂O₆. The coexistence proves that the catalyst PtO₂@CoV₂O₆ is successfully synthesized.

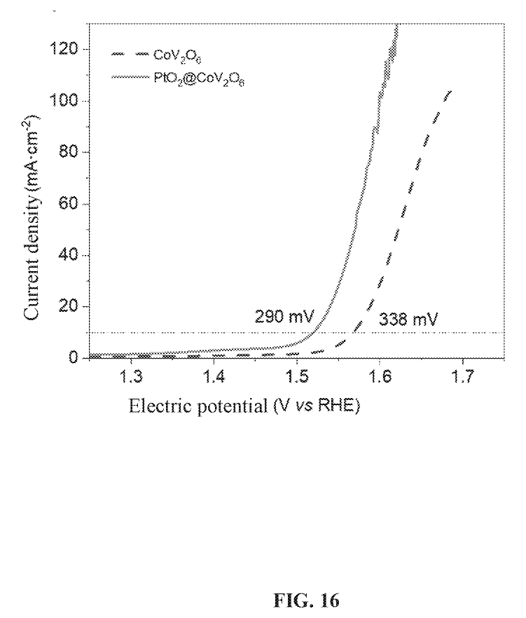

FIG. 16 is a linear sweep voltammetry curve of PtO₂@CoV₂O₆ on a glassy carbon electrode for an OER in Embodiment 3 of the present disclosure. Electrocatalytic OER performance test conditions for PtO₂@CoV₂O₆ obtained in Embodiment 3 are consistent with the conditions in Embodiment 1. As shown in FIG. 16, an overpotential required for PtO₂@CoV₂O₆ to drive a current density of 10 mA·cm⁻² on a glassy carbon electrode is 290 mV.

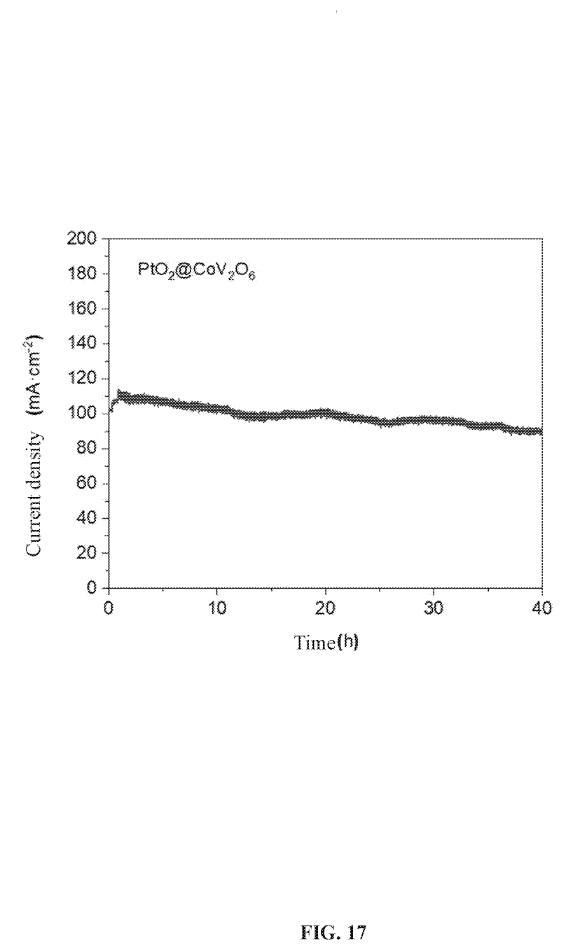

FIG. 17 is a constant current electrolysis plot of PtO₂@CoV₂O₆ at a voltage of 0.78 V in Embodiment 3 of the present disclosure. As shown in FIG. 17, PtO₂@CoV₂O₆ was electrolyzed for 40 h at a voltage of 0.78 V, and the performance of PtO₂@CoV₂O₆ decreased by only 10.2%, indicating that PtO₂@CoV₂O₆ has very good stability.

### Embodiment 4

Embodiment 4 differed from Embodiment 1 in that the concentration of the ruthenium chloride solution and the concentration of the cobalt acetate solution were changed. Other steps were the same as those in Embodiment 1.

In Embodiment 1, the concentration of the cobalt acetate solution was 0.060 mol/L, and the concentration of the ruthenium chloride solution was 0.20 mol/L. RuO₂@CoV₂O₆ prepared in Embodiment 1 was denoted as RuO₂@CoV₂O₆ -3.

In Embodiment 4, the ruthenium chloride solution and the cobalt acetate solution for each catalyst were specifically as follows.

(1) The concentration of the cobalt acetate solution was changed to 0.067 mol/L, and the concentration of the ruthenium chloride solution was changed to 0.067 mol/L, to prepare RuO₂@CoV₂O₆ -1.

(2) The concentration of the cobalt acetate solution was changed to 0.062 mol/L, and the concentration of the ruthenium chloride solution was changed to 0.15 mol/L, to prepare RuO₂@CoV₂O₆ -2.

(3) The concentration of the cobalt acetate solution was changed to 0.058 mol/L, and the concentration of the ruthenium chloride solution was changed to 0.23 mol/L, to prepare RuO₂@CoV₂O₆ -4.

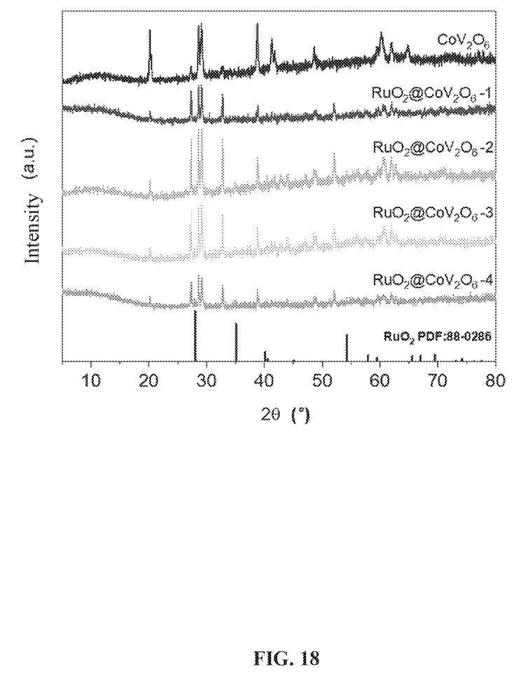

FIG. 18 is an X-ray powder diffraction pattern of RuO₂@CoV₂O₆ -1, RuO₂@CoV₂O₆ -2, and RuO₂@CoV₂O₆ -4 in Embodiment 4 of the present disclosure. "RuO₂@CoV₂O₆ -3" in FIG. 18 is the catalyst prepared in Embodiment 1. As shown in FIG. 18, similar to "RuO₂@CoV₂O₆ -3" prepared in Embodiment 1, a cobalt vanadate phase and a ruthenium dioxide phase coexist in each of the catalysts RuO₂@CoV₂O₆ -1, RuO₂@CoV₂O₆ -2, and RuO₂@CoV₂O₆ -4 prepared in Embodiment 4. The coexistence proves that each RuO₂@CoV₂O₆ catalyst with a different concentration is successfully synthesized.

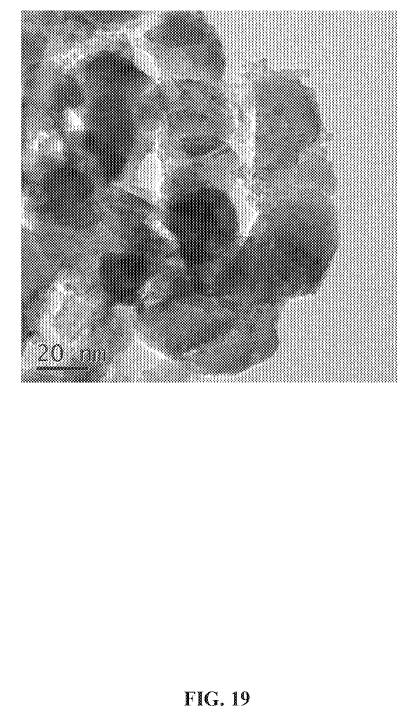

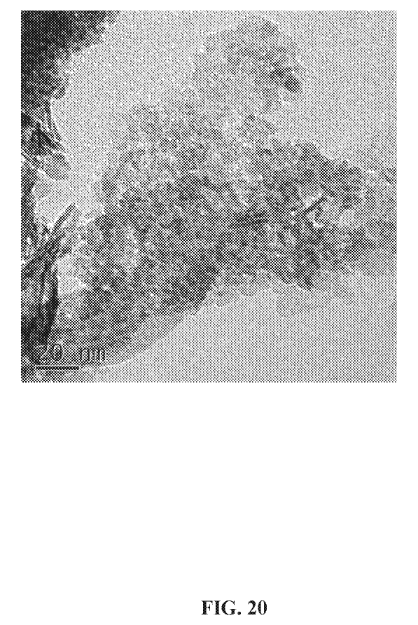

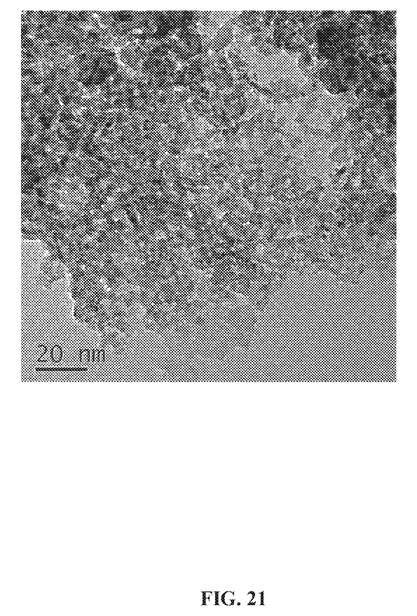

FIG. 19, FIG. 20, and FIG. 21 are transmission electron microscopy images of RuO₂@CoV₂O₆ -1, RuO₂@CoV₂O₆ -2, and RuO₂@CoV₂O₆ -4, respectively, prepared in Embodiment 4 of the present disclosure. As shown in FIG. 19 to FIG. 21, ruthenium dioxide clusters of RuO₂@CoV₂O₆ -1, RuO₂@CoV₂O₆ -2, and RuO₂@CoV₂O₆ -4 are uniformly anchored on cobalt vanadate nanosheets.

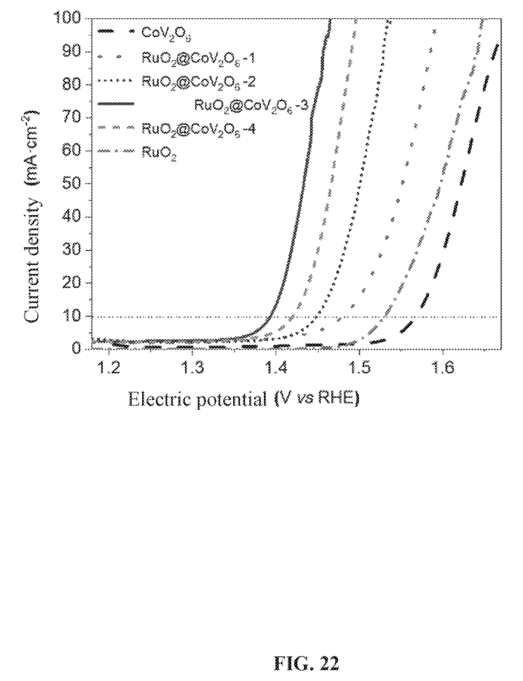

FIG. 22 is a linear sweep voltammetry curve of RuO₂@CoV₂O₆ -1 to RuO₂@CoV₂O₆ -4 on a glassy carbon electrode for an OER in Embodiment 4 of the present disclosure. Electrocatalytic OER performance test conditions for RuO₂@CoV₂O₆ obtained in Embodiment 4 are consistent with the conditions in Embodiment 1. As shown in FIG. 22, each of the catalysts RuO₂@CoV₂O₆ -1, RuO₂@CoV₂O₆ -2, and RuO₂@CoV₂O₆ -4 prepared in Embodiment 4 has a certain catalytic performance. "RuO₂@CoV₂O₆ -3" prepared in Embodiment 1 requires the overpotential of 167 mV to drive the current density of 10mA·cm⁻² on the glassy carbon electrode. "RuO₂@CoV₂O₆ -3" has the best performance, which indicates that increasing or decreasing the concentration of the ruthenium chloride solution and the concentration of the cobalt acetate solution leads to a decrease in catalyst performance.

### Embodiment 5

Embodiment 5 differed from Embodiment 1 in that a volume ratio of the cobalt acetate solution to the ruthenium chloride solution was changed. Other steps were the same as those in Embodiment 1.

In Embodiment 1, a volume of the cobalt acetate solution was 19 mL, and a volume of the ruthenium chloride solution was 1 mL. RuO₂@CoV₂O₆ prepared in Embodiment 1 is denoted as RuO₂@CoV₂O₆ -3.

In Embodiment 5, the volume of the cobalt acetate solution and the volume of the ruthenium chloride solution for each catalyst were specifically as follows.

(1) The volume of the cobalt acetate solution was changed to 18.5 mL, and the volume of the ruthenium chloride solution was changed to 1.5 mL, to prepare RuO₂@CoV₂O₆ -5.

(2) The volume of the cobalt acetate solution was changed to 18 mL, and the volume of the ruthenium chloride solution was changed to 2 mL, to prepare RuO₂@CoV₂O₆ -6.

(3) The volume of the cobalt acetate solution was changed to 17 mL, and the volume of the ruthenium chloride solution was changed to 3 mL, to prepare RuO₂@CoV₂O₆ -7.

(4) The volume of the cobalt acetate solution was changed to 16 mL, and the volume of the ruthenium chloride solution was changed to 4 mL, to prepare RuO₂@CoV₂O₆ -8.

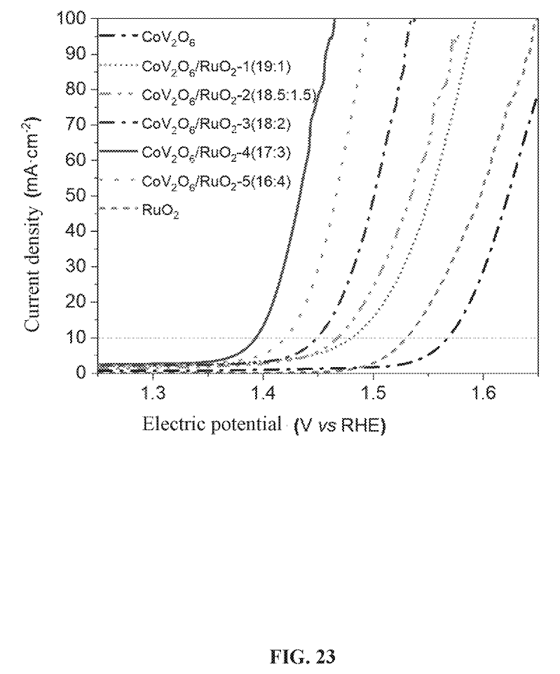

FIG. 23 is a linear sweep voltammetry curve of RuO₂@CoV₂O₆ -3 and RuO₂@CoV₂O₆ -5 to RuO₂@CoV₂O₆ -8 on a glassy carbon electrode for an OER in Embodiment 5 of the present disclosure. Electrocatalytic OER performance test conditions for RuO₂@CoV₂O₆ obtained in Embodiment 5 are consistent with the conditions in Embodiment 1. As shown in FIG. 23, when the volume ratio of the cobalt acetate solution to the metal salt solution is in a range of 3:1 to 20:1, each of the prepared catalysts RuO₂@CoV₂O₆ -3, RuO₂@CoV₂O₆ -5, RuO₂@CoV₂O₆ -6, RuO₂@CoV₂O₆ -7, and RuO₂@CoV₂O₆ -8 has a certain catalytic performance.

In the embodiments of the present disclosure, cobalt vanadate is selected as a carrier. A simple one-pot manner can be used to prepare composite materials RuO₂@CoV₂O₆, PdO@CoV₂O₆, and PtO₂@CoV₂O₆ in large batches. The composite materials have an ultrathin scale (e.g., 2 nm) and support ultrafine RuO₂ clusters, PdO clusters, and PtO₂ clusters with an average particle size (e.g., 1.0 nm). The composite materials have long-term electrochemical stability. The preparation method for the catalyst with RuO₂ clusters, PdO clusters, and PtO₂ clusters anchored on the cobalt vanadate nanosheets is simple and has a low cost. The preparation method is suitable for large-scale synthesis. The preparation method has high potential industrial application value in the field of energy catalysis. The catalyst can be used for the electrocatalytic water splitting reaction, the ORR, the CO₂RR, and various organic catalytic reactions.

Taking the electrocatalytic water splitting reaction as an example, hydrogen has a high energy density and is clean and environmentally friendly. Therefore, the electrocatalytic water splitting technology for hydrogen production has broad application prospects. Water splitting includes two half-reactions (i.e., a hydrogen evolution reaction (HER) on a cathode and the OER on an anode). Both half-reactions require the introduction of a catalyst to reduce the reaction overpotential in the electrocatalytic reaction and to improve the reaction efficiency. Some noble metals and oxides of the noble metals are currently recognized as excellent water electrolysis catalysts. However, commercial application of such catalysts is greatly limited because resources of the catalysts are scarce and the cost of the catalysts is high. RuO₂@CoV₂O₆, PdO@CoV₂O₆, and PtO₂@CoV₂O₆ have excellent OER electrocatalytic performance. The performance is superior to that of the current commercial catalyst RuO₂.

The foregoing descriptions are merely specific implementations of the present disclosure. However, the protection scope of the present disclosure is not limited thereto. Any person skilled in the art can easily conceive of changes or substitutions within the technical scope disclosed in the present disclosure. The changes or substitutions shall fall within the protection scope of the present disclosure.

What is claimed is:

1. A preparation method for a noble metal oxide cluster catalyst anchored on cobalt-based nanosheets, comprising:
mixing a cobalt acetate solution, a metal salt solution, ammonium metavanadate, and acetylene black uniformly, stirring at a temperature in a range of 50 °C to 100 °C, and filtering to collect a sample; wherein,
a metal species involved in the metal salt solution includes at least one of Ru, Pd, or Pt; and
subjecting the sample to vacuum drying, and pyrolyzing the sample under air atmosphere, to obtain the noble metal oxide cluster catalyst anchored on cobalt-based nanosheets; wherein,
a concentration of the cobalt acetate solution is in a range of 0.05 mol/L to 0.07 mol/L;
a volume ratio of the cobalt acetate solution to the metal salt solution is in a range of 3:1 to 20:1;
a mass ratio of the ammonium metavanadate to the acetylene black is in a range of 1:1 to 10:1;
the catalyst obtained by the preparation method includes ultrathin nanosheets having a thickness in a range of 1 nm to 3 nm;
the noble metal oxide loaded on the cobalt-based nanosheets is in a form of nanoclusters;
a loading amount of noble metal is in a range of 0.8 wt% to 5.1 wt%; and
an average particle size of the noble metal oxide nanoclusters loaded on the cobalt-based nanosheets is in a range of 0.7 nm to 1.5 nm.

2. The preparation method according to claim 1, wherein
the volume ratio of the cobalt acetate solution to the metal salt solution is in a range of 3:1 to 20:1, and the mass ratio of the ammonium metavanadate to the acetylene black is in a range of 1:1 to 10:1.

3. The preparation method according to claim 1, wherein a salt species involved in the metal salt solution includes at least one of a metal acetate salt, a metal chloride salt, or a vanadate.

4. The preparation method according to claim 1, wherein a concentration of the metal salt solution is in a range of 0.06 mol/L to 0.4 mol/L.

5. The preparation method according to claim 1, wherein a temperature of the vacuum drying is in a range of 50 °C to 100 °C, and a duration of the vacuum drying is in a range of 12 hours to 24 hours.

6. The preparation method according to claim 1, wherein the pyrolyzing the sample under air atmosphere includes:
heating the sample after the vacuum drying in a tube furnace under air atmosphere at a heating rate in a range of 5 °C/min to 20 °C/min to a temperature in a range of 300 °C to 500 °C; maintaining the temperature for a duration in a range of 5 h to 15 h; and naturally cooling to room temperature, to obtain the noble metal oxide cluster catalyst anchored on cobalt-based nanosheets.

7. A noble metal oxide cluster catalyst anchored on cobalt-based nanosheets, wherein the catalyst is obtained by the preparation method according to claim 1.

8. The noble metal oxide cluster catalyst anchored on cobalt-based nanosheets according to claim 7, wherein the cobalt-based nanosheets are cobalt vanadate nanosheets.
